(19) United States
(12) Patent Application Publication
(10) Pub. No.: US 2003/0028811 A1
(43) Pub. Date: Feb. 6, 2003

(54) Method, apparatus and system for authenticating fingerprints, and communicating and processing commands and information based on the fingerprint authentication

(76) Inventors: John David Walker, Melbourne, FL (US); Dennis Deruelle, Melbourne, FL (US); Gilbert Russell, Melbourne, FL (US); Brian Wetzel, Melbourne, FL (US); Timothy Yandell, Melbourne, FL (US)

Correspondence Address: David P. Lhota, Stearns Weaver Miller, et al., Suite 1900, 200 East Broward Boulevard, Fort Lauderdale, FL, 33301, US

(21) Appl. No.: 09/901,461

(22) Filed: Jul. 9, 2001

Related U.S. Application Data
(60) Provisional application No. 60/217,763, filed on Jul. 12, 2000.

(51) Int. Cl. H04L 9/32

(52) U.S. Cl. 713/202; 382/124

(57) ABSTRACT

A fingerprint authentication and communication system having a fingerprint sensor and reader that converts a fingerprint into a digital profile output, a plurality of databases for storing among other things fingerprint digital profiles, user ID's, and patient related medical information, software that determines whether a recently entered fingerprint digital profile is on the approved list for authentication, and telecommunication transceiver for communicating user selected actions over telephone lines, wireless channels and the Internet. The system is preferably concealed in a handheld product for physicians and allows medical professionals to initiate and perform a plurality of actions, such as ordering multiple prescriptions and lab tests, with a fingerprint induced command.

### CROSS REFERENCE TO RELATED APPLICATIONS

This application claims the benefit of provisional application Serial No. 60/217,763 filed Jul. 12, 2000.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

This invention relates generally to a fingerprint authentication system, and more particularly, a software based fingerprint authentication and communication system that manages and controls fingerprint related information and a plurality of actions from a set of predetermined actions based on authentication and control protocols. The invention is particularly adaptable to streamlining the practice of medicine, reducing healthcare costs and improving patient care. The invention provides a handheld product for physicians and other medical professionals that streamlines the practice of medicine by allowing a physician or authorized health care worker to initiate a plurality of actions, such as ordering multiple prescriptions and lab tests, with a fingerprint induced command.

2. Description of the Background Art

Physicians write approximately 2.5 billion prescriptions a year, only about 1% of prescriptions are transmitted electronically because of security issues and viable solutions. Approximately 40% of all written drug prescriptions require rework by pharmacies. Adverse drug events (ADE) have caused 20% of the deaths in hospitals in 1999. ADE's decline more than fifty (50) percent when physicians electronically prescribe medication. Medical mistakes are one of the leading causes of death in the United States, exceeding deaths caused by highway accidents, breast cancer, and AIDS. Moreover, the writing of prescriptions by unauthorized persons continues to be a problem as the current system is easily duplicated. These shortcomings have contributed to rising health care and drug prescription costs. It has been determined that health care costs and reliability could be improved by using and combining telecommunication, fingerprint recognition and hand held computer technologies. A device capable of electronically authenticating an authorized health care provider's credentials for electronically initiating a plurality of actions, such as ordering prescriptions and lab tests and streamlining other medical protocols in a hand held telecommunications unit would be well received. In fact, a device and system capable of electronically initiating and carrying out a plurality of prescribed and secured actions based on a fingerprint authentication result.

A number of devices are known in the background art for accessing patient related information based on a patient's fingerprint. However, there are no known devices that offer an electronic solution for controlling, accessing and providing medical information and commands in a manner that addresses or resolves the above noted shortcomings in the prior art. For instance, U.S. Pat. No. 5,193,855, issued to Shamos, discloses a patient and healthcare provider identification system including a database of patient and healthcare provider information including patient identity and fingerprint information, a fingerprint scanner, a control system for matching the fingerprint data read by the scanner with the fingerprint data stored in memory; and a printer for printing labels and stamps. U.S. Pat. No. 5,845,255, issued to Mayaud, discloses a wirelessly deployable, computerized prescription management system consisting of creating electronic prescriptions accordance with patient-condition objectives, patient record assembly, privacy/security passwords and numeric codes for identifying patients and doctors, online access to comprehensive drug information and onscreen physician-to-pharmacy and physician-to-physician e-mail. U.S. Pat. No. 5,852,670, issued to Setlak et al., discloses a fingerprint sensing device which generates a finger position indication to assist the user in positioning the finger on the device and provides personal identification and digital signature keys. U.S. Pat. No. 6,021,211, issued to Setlak et al., discloses a method and apparatus for indexing and searching a plurality of reference fingerprints to determine if a sample fingerprint matches one of the reference fingerprints.

As the foregoing background art fails to provide a fingerprint authentication and induced control device and system that authenticates fingerprints and performs a plurality of predetermined commands based on the user's fingerprint, there exists a need for such a device and system that addresses the foregoing needs. The instant invention addresses this need by providing a device and system that reads, processes, and authenticates fingerprint inputs of users and carries out predetermined commands or actions if it recognizes it as being valid.

### SUMMARY OF THE INVENTION

The instant invention comprises a method, system and/or apparatus that reads and processes fingerprints, authenticates the fingerprint input, and carries act commands based on valid authentication for controlling, accessing, requesting, and/or providing medical information. The instant invention may be used with other types of information in different industries that may require the remote transfer and access to predetermined information and the ability to reliably and electronically authenticate the identity of the user requesting and/or providing the information. The method, system and apparatus of the invention is software and hardware based and comprises a plurality of processor readable code, a storage medium for storing the code, and a microprocessor based unit having telecommunication capability for transmitting digital information in the form of voice data, a fingerprint sensor for reading and/or digitizing a fingerprint profile, hardware and software for requesting, transferring and/or receiving information and inducing predetermined actions based on signals generated by the fingerprint sensor. The invention may also include code for comparing the fingerprint generated signal with stored data to authenticate the user and the user's request. Upon authentication, the user may receive predetermined information, such as medical records or business records, and process or transmit information such as medication prescriptions and process commands such as ordering prescriptions, lab tests, or any type of product or service. Medication, patient product and service, specific codes are created and stored in a database and read in conjunction with fingerprint authentication could be used to match patients with medication and dosages in response to and based on the fingerprint authentication.

Based on the foregoing it is a primary object of the instant invention to provide a software based device and system that can initiate a plurality of commands based on a fingerprint input.

It is another object of the instant invention to provide a fingerprint recognition and communication system that receives, reads, processes and authenticate a user's fingerprint and initiates user requested actions if the fingerprint is authenticated.

It is also an object of the instant invention to provide a fingerprint recognition and communication system that receives, reads, processes and authenticate a user's fingerprint and can communicate and process a plurality of user requested actions, including ordering prescriptions, ordering lab tests and retrieving and providing patient related information.

It is an additional object of the instant invention to provide a fingerprint recognition and communication system that is software driven from a hand-held or laptop processor and telecommunication device, such as a Palm Pilot®, for receiving, reading, processing and authenticating user fingerprint inputs and preselected actions.

It is a further object of the instant invention to provide a software driven fingerprint recognition and communication system that can authenticate the user based on the user's fingerprint input and communicate or carry out commands related to purchasing or obtaining requested goods and/or services.

In accordance with these and other objects, which will become apparent hereinafter, the instant invention will now be described with particular reference to the accompanying drawings.

### DETAILED DESCRIPTION OF THE INVENTION

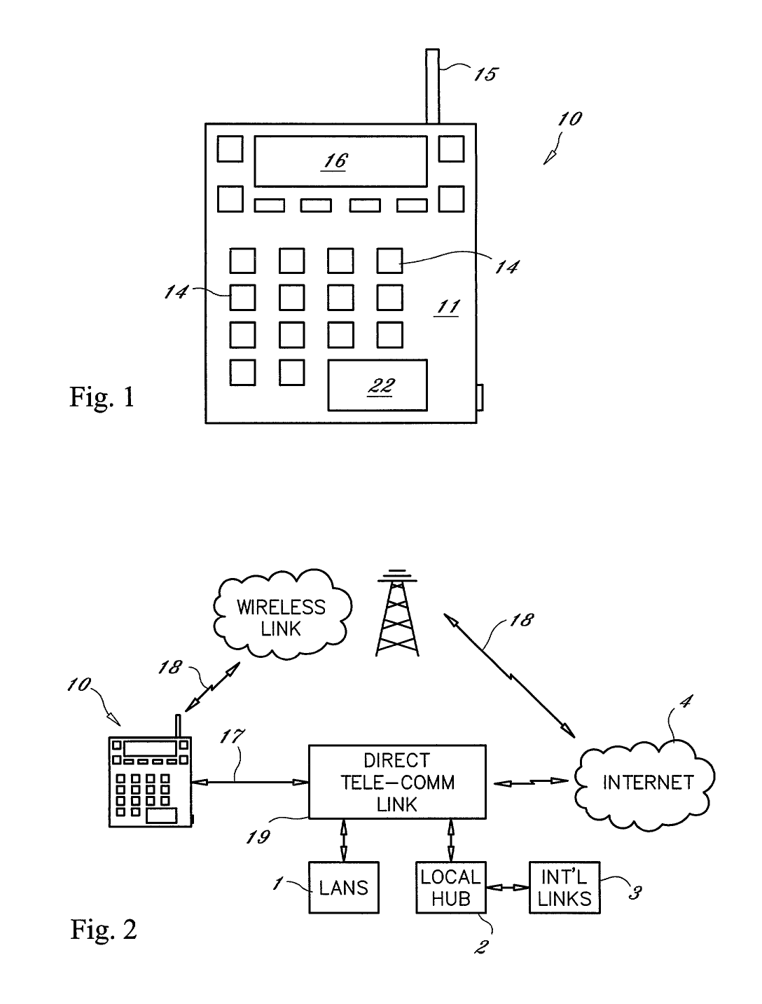

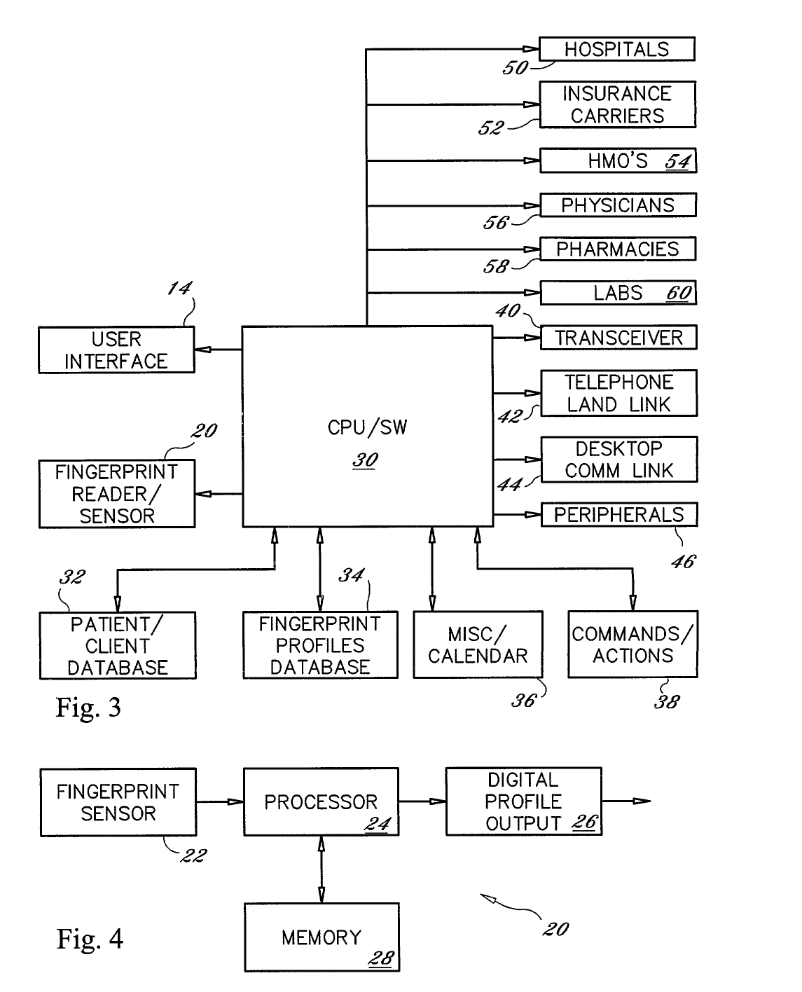

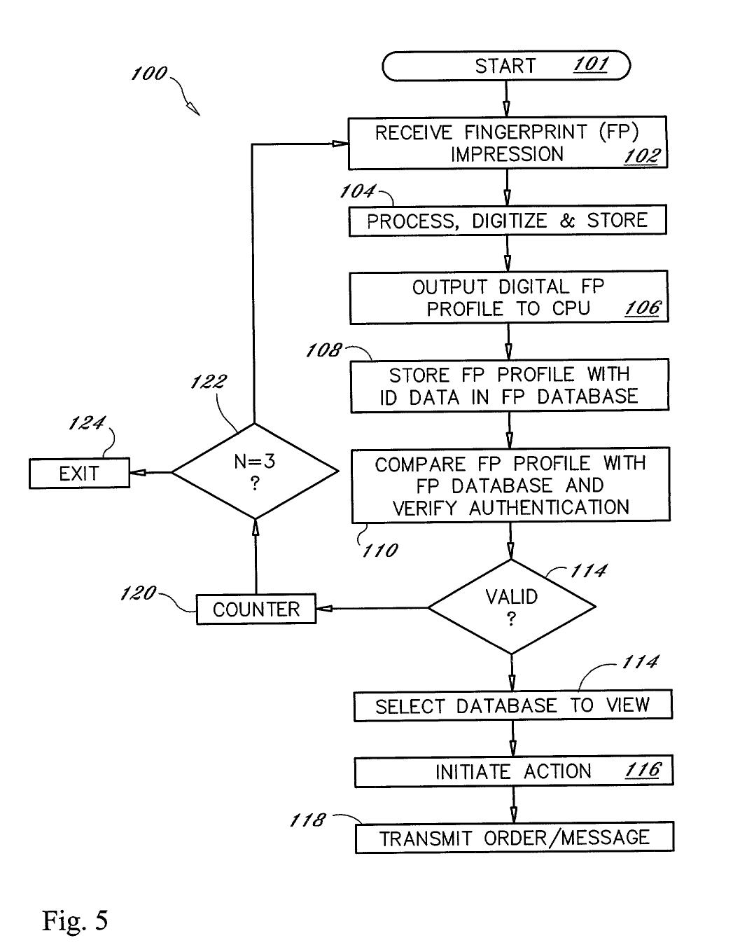

With reference to the drawings, FIGS. 1-5 depict the preferred embodiment of the instant invention which is referenced by numeric character 10 or as a fingerprint authentication and communication system 10. The instant invention 10 comprises a method, system and/or apparatus 10 for reading, storing, retrieving and processing fingerprint inputs to determine authenticity or validity and processing user driven actions, such as ordering prescriptions or lab tests, if the fingerprint is validated. With reference to FIG. 1, the instant invention 10 is preferably adapted for use in a hand-held processor 11, such as a programmable cellular phone, slate computer, Palm Pilot or Blackberry, as is known in the art. The instant invention 10 may also be adapted for laptop and desk top computers. Referring to FIG. 1, the fingerprint authentication and communication system 10 comprises a housing 11, user interface key pad 14 having a plurality of keys, antenna 15, viewing screen 16, fingerprint processor 20 (shown in FIG. 4), fingerprint sensor/keypad 22 and a set of processor readable instructions 100 (“authentication program” shown in FIG. 5) that are processed by a central processing unit 30 (“CPU” shown in FIG. 3). A user's fingerprint is received, sensed and read upon pressing a designated finger, such as the index finger, against the sensor keypad 22, shown in FIG. 1. The fingerprint sensor pad 22 may comprise a ¾″ to 2″ square, circle, oval or rectangular pad on the housing 11 or a touch screen 16. The processing of fingerprint inputs is software driven as indicated by the CPU 30 and authenticaion program 100. The program 100 compares the fingerprint input with known fingerprint profiles to see if the user is authorized to access any or all data therein and initiate any or all commands. If the user's fingerprint is validated, then the user is authorized and cleared to transact all or predetermined commands and actions, such as ordering prescriptions or lab tests, or accessing and contacting a physician, hospital or insurance company. Actions, commands, communications are selected and activated using the key pad 14. The number of keys may vary without departing from the scope and spirit of the invention. Upon validation, new users are preferably assigned an identification number or ID for identifying, communicating and processing information and inputs made by the user. The extent of a user's authorization is determined by the user profile stored in the fingerprint profiles database 34 or some other designated database. It should be noted that although the invention is preferably employed and adapted for the medical industry, it may be tailored for other businesses as well where remote and secured access to a database of data and commands and telecommunication capabilities would be desired, such as in the financial markets for buying and selling stocks and commodities and businesses that order and sell products.

Once a user has been validated, the invention 10 authorizes user activity such as transmitting requests, placing orders or communicating with a designated location, person or network. With reference to FIG. 2, communications to pharmacies, hospitals, labs or other designated locations may be transmitted by known wireless and wired links 18, 19 and telecommunication systems. A telecommunications cable 17 is used to connect to and access a direct telecommunication link, such as a telephone jack. The Internet 14 and other available communication networks, such as local area networks (“LAN's”) and local Internet provider hubs that allow for more efficient communication with international links, are preferably accessible through wireless links 18 and are also accessible through wired links 19, as shown in FIG. 2. The remote hand-held device or other wireless device 11 preferably employs a transceiver 40 compatible with known wireless systems, such as a packet switching network (PSN) or any packet, cell or similar network in which voice and data are transmitted in discrete quanta to access or communicate with a designated system or network based on the user's identification or assigned ID number. Optionally, the invention may employ Cellular Digital Packet Data (CDPD) technology or other known wireless publicly accessible communication technology. PSN is preferred in communications targeted to the Internet 14 because of its compatibility with the Internet 14. Land line links 19 may be accomplished through a modem, cable modem, DSL, T1, T3 or other public communication networks.

With reference to FIG. 3, the system of the instant invention 10 preferably comprises a CPU 30, authentication program 100, fingerprint reader/sensor 20, at least one database 32, 34 for storing and retrieving fingerprint profiles and other predetermined information related to patients or a doctor's practice, transceiver 40 or comparable unit for the wireless transmission and receipt of voice communications and data, housing 11 for securely concealing the foregoing and user interface 14 for accessing and manipulating the foregoing. The invention 10 may further comprise input/output (I/O) ports for peripherals such as printers, scanners and larger screens, desktop or laptop computer links 44 for synchronizing a computer with the unit 10, telephone land line link 42 such as a telephone jack for directly accessing the Internet or other network, and additional databases for storing, retrieving and using data, such as a commands and actions database 38, miscellaneous and calendar database 36, hospitals database 50, insurance carriers database 52, HMO's database 54, physicians database 56, pharmacies database 58 and labs database 60. It should be noted that the databases 32-38 and 50-60 may comprise one or more partitioned databases. The information in the databases 32-38 and 50-60 are accessed using the keypad 14, which provides a user interface to the CPU 30, program 100 and databases. The CPU 30 stores, runs and processes the authentication program 100 based on inputs from the fingerprint reader 20 and user interface 14. The fingerprint profiles are stored in a database 34 (shown in Fig. FIG. 3) as digital data files and preferably with user ID's. The fingerprint processor 20 digitally converts and stores the user fingerprint input as a digital fingerprint profile of the user. Referring to FIG. 4, the fingerprint reader/processor 20 preferably comprises a sensor 22, processor 24, memory 28 and digital profile output 26. The fingerprint processor 20 may comprise an apparatus such as that disclosed in U.S. Pat. No. 5,852,670, which is incorporated herein by reference. The fingerprint profile output 26 is fed into the CPU 34 and stored in the fingerprint profiles database 34. The CPU 30 and program 100 processes the fingerprint profile, comparing it to a list of approved fingerprints with ID's in the database 34 and provides a response tantamount to accepting or rejecting the fingerprint input and requested actions. If approved, the user is given access to one or more of the databases 32-38 and 50-60 and access to one or more of the commands and actions stored in database 38. For instance, in one application a user may be a doctor that inputs his unique fingerprint, receives access, pulls up a patients current medication and medical history, prescribes medication and orders a lab test of the patient's tissue or blood. When initiating an action, such as ordering medication or lab tests, the CPU 30 processes the requests and transmits the request to a designated target over a wireless or wired link when the action is confirmed, such as by touching the sensor pad 20 again with a designated finger. In the preferred embodiment, the user is able to simultaneously initiate a plurality of actions and orders with one touch of the finger.

With reference to FIG. 5, the authentication program 100 and modes of use are generally depicted. The program 100 begins upon powering up the unit 10 and pressing the correct finger against the fingerprint sensor pad 20. The sensor pad 20 receives, stores and creates a fingerprint profile that is outputted to the CPU 30 (104-106). The fingerprint profile is then stored in the fingerprint database 34 if not already stored and processed to determine if the user has clearance for access (108-110). The program 100 preferably compares the current user fingerprint profile with those stored in the fingerprint database 34 to see if it is authentic and active (112). Other fingerprint authentication devices may be employed, such as that made by Authentec, Inc and disclosed in U.S. Pat. No. 6,021,211, which is incorporated herein by reference. If a match is not found, the user is given another opportunity to input their fingerprint. After a predetermined number of tries, such as three, the program 100 and unit 10 are shut down temporarily or semi-permanently, that is until the unit is unlocked. Once the fingerprint input is authenticated the user is given access to the databases 32-38 and 50-60 and commands to issue and place orders and actions, such as those above noted (114-118). The fingerprint authentication and communication system 10 disclosed herein may be used to manage medical and patient information, such as that stored in databases 5060. The invention 10 may also dial telephone numbers for telephone, facsimile or network communications upon making a selection from a database 32-38 and 50-60. The program 100 may further incorporate a prescription management system such as that disclosed in U.S. Pat. No. 5,845,255, which is incorporated herein by reference.

The fingerprint authentication and communication system 10 provides a plurality of predetermined actions that are initiated or carried out based on the results and communications received or extracted from the fingerprint recognition system 10. The invention 10 provides a telecommunications based platform for storing, processing and communicating information and commands to a predetermined location through known telecommunication devices and channels, as noted above, for controlling, accessing and/or providing medical information and commands. The instant invention may be used with other types of information in different industries that may require the remote transfer and access to predetermined information and the ability to reliably and electronically authenticate the identity of the user requesting and/or providing the information. The method, system and apparatus of the invention 10 is software and hardware based as described herein. Upon authentication of a user's fingerprint, the user may receive predetermined information, such as medical records or business records, and process or transmit information such as medication prescriptions. Medication specific codes may be used in conjunction with fingerprint authentication codes and stored in and accessed from databases 32 and/or 34 to match patients with medication and dosages in response to and based on the fingerprint authentication. The system of the invention affords the immediate posting of prescriptions, updating of patient records, completion of forms, handling insurance or other actions, with the touch of a finger on the sensor 22.

The invention comprises a fingerprint recognition system 10 that generates and processes digital signatures using fingerprint recognition technology as described herein, and incorporates a one-touch authentication system that triggers various routines for authenticating the user and processing the user's request. For instance, when an individual places his finger on the sensor pad 22, the invention 10 transmits the signature and the date and time electronically, which initiates the recognition code for identifying and authenticating the signature and/or the code for processing the request. The fingerprint signatures are previously captured or recorded digitally for comparison with the transmitted signature, as noted above.

One portable computer that may be employed with the invention comprises the Qbe Personal Computing Tablet, which offers a handheld platform capable of replacing the desktops and limited palmtop devices that professionals are currently using. The fingerprint feature may be used in conjunction with or without preloaded signatures and a means for comparing submitted signatures with stored signatures. A high speed central server delivers content and processes banner and healthcare information. An integrated color camera may be included on the tablet, which can provide the machine with eyes to see the user, as well as picture and video playing and/or recording capabilities. Natural handwriting may be made possible with the tablet selected, as well as direct-to-screen interface and software that learns the writer's style. A unit with a touch screen should allow for greater use of touch navigation, which creates a truly mobile “kiosk” environment. The unit may also include video conferencing, cellular phone, wireless access to the Internet, and e-mailing.

The invention preferably includes a fill range of features requested by the medical professional. The instant invention may include one or more of the following:

Fingerprint authentication in an integrated unit for optimum security of medical information.

Electronic Medical Records (EMR), Charting

Dictation (with electronic link to EMR)

Electronic prescriptions

Ordering of lab tests, notification of results

Legal document repository

Dosing, adverse reactions, drug-drug interactions

Direct links to managed care databases for alternate drugs

CME (Continuing Medical Education) video sessions

CDC (Center for Disease Control) outbreak notices

Medline healthcare references

Internet Access

Email and Pager function

Headline and Medical News flashes. Journal subscriptions (i.e..JAMA).

Appointment/calendar function

Business applications (billing, insurance, etc)

General MS Office computing (word processing, spreadsheets, presentations)

The instant invention has been shown and described herein in what is considered to be the most practical and preferred embodiment. It is recognized, however, that departures may be made therefrom within the scope of the invention and that obvious structural and/or functional modifications will occur to a person skilled in the art.

What is claimed is:

1. A fingerprint authentication and communication apparatus, said apparatus comprising:
fingerprint means for receiving, processing, creating and outputting a digital fingerprint profile of a detected fingerprint;
processor in electrical communication with said fingerprint means for receiving said digital profile;
a user interface means, in electrical communication with said microprocessor, for receiving user inputs;
at least one database in electrical communication with said processor for storing for subsequent retrieval a plurality of previously stored digital fingerprint profiles and predetermined information;
processor readable set of instructions readable and processed by said microprocessor, said instructions comprising:
means for reading a selected digital fingerprint profile;
means for determining whether said selected digital profile is stored in said database and valid;
means, in communication with said determining means, for authorizing and processing said user inputs and for initiating a user command; and
a telecommunication means, in electrical communication with said processor, for transmitting said user command to a predetermined location accessible over a telecommunications network and designated for fulfilling said user command.

2. An apparatus as recited in claim 1, further comprising a means for communicating with said predetermined location through a wireless communication link.

3. An apparatus as recited in claim 1, wherein said fingerprint means comprises a fingerprint sensor that obtains an image of a fingerprint placed on said sensor and means for converting a fingerprint input to said dgital fingerprint profile.

4. An apparatus as recited in claim 1, further comprising a database, in electrical communication with said processor, said database comprising medical information related to predetermined patients.

5. An apparatus as recited in claim 4, further comprising a database in electrical communication with said processor and comprising information related to predetermined facilities that are in predetermined medical related industries.

6. An apparatus as recited in claim 1, wherein said instructions further comprise means for ordering medical prescriptions from a remote location through said telecommunications means.

7. An apparatus as recited in claim 1, wherein said instructions further comprise means for ordering medical lab tests from a remote location through said telecommunications means.

8. An apparatus as recited in claim 1, wherein said instructions further comprise means for ordering predetermined goods and services from a remote location through said telecommunications means.

9. An apparatus as recited in claim 1, further comprising a database of commands and actions.

10. An apparatus as recited in claim 1, further comprising a database for storing an electronic calendar.

11. An apparatus as recited in claim 1, wherein said user interface comprises a key pad.

12. An apparatus as recited in claim 1, further comprising a means for linking to a computer for synchronizing information in said apparatus with corresponding information in said computer.

13. An apparatus as recited in claim 1, further comprising means for communicating with a printing device.

14. An apparatus as recited in claim 1, further comprising means for communicating with a printing device.

15. An apparatus as recited in claim 1, further comprising means for communicating with a land line telecommunication system.
